(19) United States
(12) Patent Application Publication
(10) Pub. No.: US 2026/0348810 A1
(43) Pub. Date: Nov. 5, 2026

(54) MULTIMODAL HELMET EVALUATION SYSTEM AND METHOD

(71) Applicant: VIRGINIA TECH INTELLECTUAL PROPERTIES, INC., Blacksburg, VA (US)

(72) Inventors: Lauren Alexandra Duma, Blacksburg, VA (US); Barry Miller, Blacksburg, VA (US); Steven Rowson, Blacksburg, VA (US); Mark Begonia, Christiansburg, VA (US)

(21) Appl. No.: 19/651,998

(22) Filed: Apr. 20, 2026

Related U.S. Application Data
(60) Provisional application No. 63/790,903, filed on Apr. 18, 2025.

(51) Int. Cl. G01N 3/30

(52) U.S. Cl. CPC G01N 3/30; G01N 2203/0039

(57) ABSTRACT

Embodiments for evaluating injury mitigation performance of helmets used for sports (e.g., equestrian sports) are described. In one embodiment, a method for evaluating a helmet includes applying a pendulum impact test and an oblique impact test to one or more helmets. The method further includes obtaining a plurality of linear and angular acceleration values associated with each of the pendulum impact test and the oblique impact test. The method further includes determining a plurality of injury risk values associated with each of the pendulum impact test and the oblique impact test based at least in part on the linear and angular acceleration values. The method further includes determining an overall injury risk metric for the one or more helmets based at least in part on the plurality of injury risk values and a plurality of exposure values associated with each of the pendulum impact test and the oblique impact test.

### CROSS REFERENCE TO RELATED APPLICATIONS

This application claims the benefit of and priority to U.S. Provisional Application No. 63/790,903 filed Apr. 18, 2025, the entire contents of which is hereby incorporated herein by reference in its entirety. This application is also related to U.S. Non-Provisional patent application Ser. No. 18/363,293 filed on Aug. 1, 2023, the entire contents of which is hereby incorporated herein by reference in its entirety.

### BACKGROUND

Over 30 million people ride horses yearly in the United States, and there are over 50,000 emergency room visits due to equestrian injuries. Equestrian sports encompass a wide range of disciplines, including Western riding, horse racing, and English events such as dressage, show jumping, and cross country. Across these disciplines, the most common mechanism of injury is falling from the horse and impacting the ground. These falls result in equestrian sports having a higher risk of severe injury compared to both American football and motorcycling. Moreover, equestrian sports are the greatest contributor of sports-related traumatic brain injuries (TBI), contributing 45 percent (%) of all sports-related TBIs. Of all injuries obtained through equestrian sports, head injuries are the most dangerous and life-threatening, resulting in the majority of hospitalizations and deaths from equestrian sports. In addition to severe head injuries, equestrian falls frequently result in mild head injuries such as concussions. Concussions are one of the most common injuries obtained in equestrian sports.

When worn, helmets have been shown to reduce head injuries by 30% and severe head injuries by 50% in equestrian sports. While this demonstrates that equestrian helmets can reduce head injury risk, the overall injury rates indicate that there is room for improvement in equestrian helmet design. Given the high number of head injuries in equestrian sports, it is imperative to have high quality helmets and intensive helmet standards to evaluate their impact performance. Currently, there are many pass or fail equestrian helmet standards used to regulate equestrian helmet performance. These standards include the ASTM F1163-23, EN 1384:2023, NOCSAEND050, PAS 015:2011, SNELL E2021, and VG1 01.040. Each of these standards involve linear drop tests onto flat, hazard, or hemisphere anvils. To pass the test, helmets must have a peak linear acceleration under a certain threshold. These standards set minimum performance requirements for equestrian helmets.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a cross-sectional view of an example headform that can be used for impact testing of helmets in accordance with various embodiments of the present disclosure.

FIG. 2 illustrates an adapter that can be used to connect the example headform shown in FIG. 1 to a neck structure in accordance with various embodiments of the present disclosure.

FIG. 3 illustrates a side view of the example headform shown in FIG. 1 with the adapter secured to the example headform in accordance with various embodiments of the present disclosure.

FIG. 4A illustrates a pendulum impact testing apparatus in a resting position in accordance with various embodiments of the present disclosure.

FIG. 4B illustrates the pendulum impact testing apparatus impacting the example headform shown in FIG. 1 in accordance with various embodiments of the present disclosure.

FIGS. 5A-5C illustrate close-up views of an impactor striking various locations of a helmet positioned on the example headform shown in FIG. 1 in accordance with various embodiments of the present disclosure.

FIG. 6 illustrates an example impact algorithm in accordance with various embodiments of the present disclosure.

FIG. 7 is a flowchart illustrating exemplary steps of a method to evaluate concussion mitigation performance of helmets in accordance with various embodiments of the present disclosure.

FIG. 8A illustrates a view of an oblique impact testing apparatus in its resting position before activation according to various embodiments of the present disclosure.

FIG. 8B illustrates a view of a helmeted headform positioned in a left front boss impact position on the oblique impact testing apparatus shown in FIG. 8A according to various embodiments of the present disclosure.

FIG. 8C illustrates a view of a helmeted headform positioned in a right front boss impact position on the oblique impact testing apparatus shown in FIG. 8A according to various embodiments of the present disclosure.

FIG. 8D illustrates a view of a helmeted headform positioned in a left rear boss impact position on the oblique impact testing apparatus shown in FIG. 8A according to various embodiments of the present disclosure.

FIG. 8E illustrates a view of a helmeted headform positioned in a right rear boss impact position on the oblique impact testing apparatus shown in FIG. 8A according to various embodiments of the present disclosure.

FIG. 9 illustrates an example oblique impact algorithm in accordance with various aspects and embodiments of the present disclosure.

FIG. 10 is a flowchart illustrating exemplary steps of another method to evaluate concussion mitigation performance of helmets in accordance with various embodiments of the present disclosure.

### DETAILED DESCRIPTION

Various embodiments of the present disclosure are directed to a multimodal test system and methods for evaluating various helmets such as equestrian helmets and construction safety helmets (e.g., hard hats), among others. More specifically, described herein is a multimodal helmet evaluation system that can be used to evaluate the biomechanical performance and risk of head injury for various helmets including equestrian helmets, construction safety helmets, and other helmets. In some examples, the multimodal helmet evaluation system accounts for various impact information specific to equestrian helmets, activities, venues, and/or accidents. Examples of such information include linear and rotational kinematics data associated with common equestrian falls and equestrian fall exposure data associated with common impact locations on equestrian helmets, among other information.

Although many examples herein are described in the context of equestrian helmets, the present disclosure is not so limited. The multimodal helmet evaluation system and methods can be implemented to evaluate many different types of helmets and protective head gear used in various sports and activities including, but not limited to, construction safety helmets or hard hats and equestrian helmets. Current equestrian helmet standards used to regulate equestrian helmet performance include the ASTM F1163-23, EN 1384:2023, NOCSAE ND050, PAS 015:2011, SNELL E2021, and VG1 01.040. Each of these standards are pass or fail and involve linear drop tests onto flat, hazard, or hemisphere anvils. To pass the test, helmets must have a peak linear acceleration under a certain threshold. While these standards set minimum performance requirements for equestrian helmets, there is currently a lack of data available that can be used to compare equestrian helmets that have passed these standards.

Current equestrian helmet evaluation standards are similar to many historical helmet evaluation standards, and they only evaluate a linear acceleration component. However, as head impacts involve both linear and rotational acceleration, it is important to assess a helmet's ability to reduce both. During a head impact, linear acceleration induces transient intracranial pressure gradients leading to focal injuries, while rotational acceleration increases brain strain, causing diffuse injuries. Previous research has shown that rotational acceleration measurements are an important indicator of a helmet's ability to reduce brain injury risk. To evaluate the role of rotational acceleration in head injuries specific to equestrian sports, some studies have used computer models to simulate head impacts observed in equestrian falls. These simulations demonstrated that rotational acceleration resulting from equestrian falls causes increased brain strain, and that angular kinematics should be included in equestrian helmet standards. Other research has also concluded that the current equestrian helmet standards, such as EN 1384, are not representative of real-world equestrian head impacts. One study found that the acceleration threshold for the EN 1384 standard was higher than reconstructed equestrian head impacts that resulted in concussions. These studies suggest that the current equestrian helmet standards do not thoroughly assess a helmet's ability to reduce brain injuries.

The Summation of Tests for the Analysis of Risk (STAR) is another helmet rating system that has been developed for several sports, such as football, hockey, bicycling, soccer, snow sports, and whitewater. The STAR helmet ratings are publicly accessible, with the goal of supplementing current helmet standards and helping consumers compare the protective ability of the available helmets in different sports. Each STAR helmet rating system is based on observed head injury mechanisms for the specific sport, and lab testing involves multiple impact locations and velocities that match the sport's individual injury mechanisms.

Impact testing involves both centric and non-centric impacts, as previous studies have highlighted the importance of centric and non-centric configurations in concussion events. The resultant peak linear and rotational head accelerations from impact tests are used to estimate concussion risks, which are multiplied by head impact exposure to calculate weighted injury risks for the given impact conditions. The weighted risks are summed to compute an overall STAR score, a single value that summarizes helmet performance across various sport-specific impact conditions. To aid in consumer interpretation, the STAR score is categorized into a rating out of 5 stars. A high rating indicates that a helmet is able to reduce head acceleration meaningfully and, therefore, also reduce concussion risk relative to other helmets in that sport. On-field studies have demonstrated that helmets highly rated by the STAR system are able to reduce head injury rates. For example, in a study of 1,833 football players across eight Division 1 universities, the 4-star Riddell Revolution reduced concussion risk by 54% compared to the 1-star Riddell VSR4. Further, helmets that reduce linear and rotational kinematics in the lab have been shown to reduce concussion risk on the field for NFL players.

A STAR rating system has been previously designed for equestrian helmets. A previous Equestrian STAR rating system was developed through a series of studies to design a system and method of testing equestrian helmets in the lab that represents the head impacts equestrians experience in the field. Analysis of equestrian fall videos and previously published equestrian fall data were used to determine common head impact locations and fall heights. Using these head impact configurations, equestrian helmets were tested on-field to generate linear and rotational acceleration traces of equestrian head impacts to the ground. A pendulum impactor with a flat impactor surface, which was found to produce the highest head accelerations for the impact speeds tested, was used for testing as it reasonably matched the acceleration magnitudes and durations measured on-field. The previous Equestrian STAR rating system tested 49 equestrian helmet models on the pendulum impactor, finding a wide range in equestrian helmet performance under linear-driven impact conditions. The best-performing helmet had a STAR score 88% lower than the worst-performing helmet, representing a significant reduction in predicted concussion rates.

However, previous Equestrian STAR rating system does not consider high-speed falls where the head impacts the ground at an angle, which have been observed in equestrian events such as horse racing and hunter and jumper events. Falls in these events frequently occur while the horse is galloping, resulting in oblique head impacts with both normal and tangential velocity components. Further, the International Federation for Equestrian Sports (FEI) has proposed a new standard to assess equestrian helmet performance under oblique impact conditions. The FEI recommended that equestrian helmets be tested on an oblique drop tower at an impact velocity of 6.56 meters per second (m/s) and that passing helmets have a peak linear acceleration under 150 g and a peak rotational acceleration under 5500 radians per second squared (rad/s²). These acceleration thresholds represent approximately a 50% risk of concussion, estimated using a concussion risk function (Eq. 1) described further herein. The 6.56 m/s impact velocity corresponds to a 2.2 meter (m) drop height, which matches the average height of an equestrian's head while on a horse and is in the upper range of fall heights possible in equestrian sports.

Some examples herein evaluate equestrian helmet performance under oblique impact conditions and compare the oblique impacts recommended by the FEI to the linear-driven impacts performed in the previous Equestrian STAR examples. Based at least in part on such evaluation and comparison described further herein, it was determined that oblique testing provides different information about equestrian helmet performance compared to pendulum testing. Embodiments herein leverage such oblique testing information in the form of an updated Equestrian STAR system and methodology that captures and uses data from both oblique and pendulum impacts. The updated Equestrian STAR addresses the limitations in current equestrian helmet standards by including rotational kinematics, both linear-driven and oblique impacts, concussion risk assessment, and equestrian fall exposure.

As noted above, both linear and angular acceleration occur during head impacts, and it is important to evaluate angular acceleration relative to brain injuries as part of impact testing of helmets. By lowering both linear and angular acceleration in laboratory tests, it has been shown that brain injury risk is lowered in real-world head impact events. Given the serious head injuries observed in equestrian sports, both linear and angular acceleration measures should be analyzed when evaluating the biomechanical performance of helmets for equestrian sports and similar activities.

In addition to not accounting for angular acceleration, other limitations of current equestrian helmet evaluation standards are that they are pass/fail and they only include testing at a single energy level (e.g., a single impact velocity). The limitations described above reduce the ability of current standards to access helmet performance. Further, research suggests that at least one of the current equestrian helmet evaluation standards is not representative of real-world equestrian head impacts, as the linear acceleration threshold for such a standard was higher than reconstructed real-world impacts that resulted in concussions. For at least the reasons described above, current standards are not only unable to differentiate between helmets that have passed the standards, but they are also unable to accurately assess a helmet's ability to reduce head injuries.

Some current equestrian helmet evaluation methodologies use linear and rotational acceleration data obtained for a limited number of specific equestrian helmets, to evaluate and compare such helmets. However, although such current methodologies may provide viable and useful performance information pertaining to a limited number of specific equestrian helmets, they are limited in scope, as they cannot be applied to evaluate the very large number of other available equestrian helmets.

According to various embodiments, a testing method can measure or evaluate the concussion mitigation performance of helmets (e.g., equestrian helmets, hard hats or construction safety helmets) used for sports, such as for equestrian sports or activities. The method is referenced herein as a STAR method in some examples, but variations of the method can be practiced based on the concepts described herein, regardless of the use of any shorthand names. Although the embodiments of the present disclosure will discuss the STAR method with reference to equestrian helmets, any suitable helmet used for sports or similar activities may be evaluated using the STAR method described herein.

The STAR method combines impact testing of helmets with an injury risk function as well as exposure data to generate a summary of helmet performance. Impact testing of helmets may be carried out with various dummy headforms that are mounted on various dummy necks. For example, one such configuration can include an equestrian helmet positioned on a NOCSAE® headform that has been mounted on a Hybrid III neck. The NOCSAE® headform and the Hybrid III neck correspond to one example configuration, and other configurations involving dummy headforms and necks may be used for impact testing without departing from the spirit and scope of the embodiments presented herein.

Instrumentation can be positioned within the headform that measures linear acceleration, angular velocity, angular acceleration, and other inertial measurements. In some cases, angular acceleration may be determined from measured angular velocity. Impact tests can be performed at a range of impact locations and energy levels that include both centric and non-centric impact configurations, which can affect the evaluation of concussion mitigation performance. For each impact test, the peak linear and angular acceleration values are inserted into a brain injury risk function, and the values from the brain injury risk function can be multiplied by an exposure value to obtain a weighted risk value.

The weighted risk values from the impact tests can be further evaluated using a function or equation. The function or equation aggregates the data from the impact tests into a number or metric, as a score representative of the performance of helmets. The score can then be used to categorize helmets into a rating system that includes numerical ranges (e.g., 0-5 with 5 being the best performing category). Helmets with higher ratings do a better job of managing impact energy and ultimately lowering the linear and angular acceleration values the head would experience for a given impact. The appeal of the rating system is that it can differentiate complex helmet performance into usable information for consumers. Moreover, on-field studies have shown brain injury reduction rates in athletes who wear higher rated helmets.

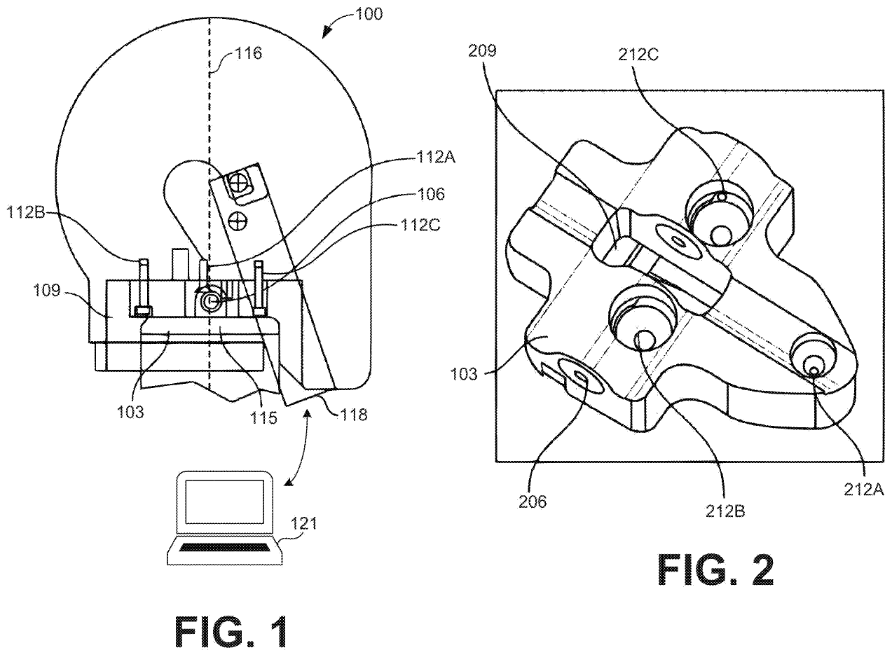

Turning to the drawings, FIG. 1 shows a cross sectional view of a headform 100 that can be used for impact testing of helmets (e.g., equestrian helmets, hard hats or construction safety helmets) used for contact sports or other activities according to the methods described herein. The headform 100 includes an opening 109 in a lower region (toward the chin of the headform 100), a sensor package 118, fasteners 112A-112C, an occipital condyle pin 106, and an adapter 103.

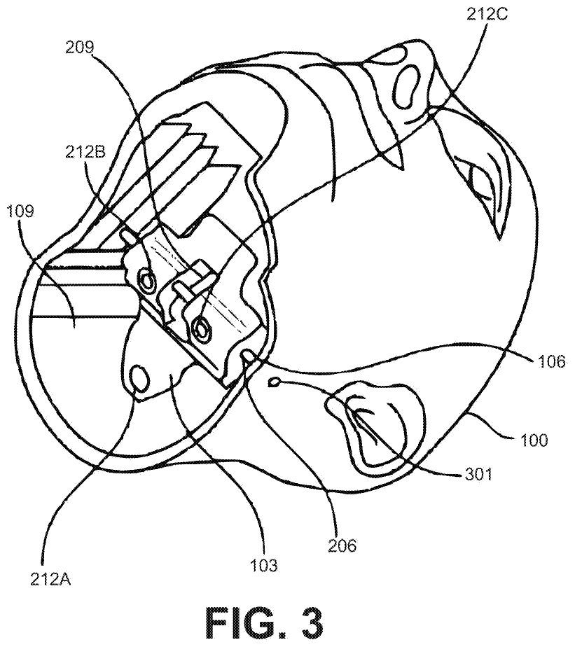

FIG. 1 also illustrates a portion of a neck 115 that attaches to the headform 100 through the adapter 103 at the opening 109. The adapter 103 can be used to mount the headform 100 to the neck 115. In this respect, the adapter 103 can include a custom adapter plate that provides anatomically accurate relative locations of the occipital condyle pin 106 and center of gravity 116 of the headform 100. In some embodiments, the headform 100 and the neck 115 can include a NOCSAE® headform and a Hybrid III 50^{th} percentile neck, respectively. However, other combinations of dummy headforms and necks can be used to conduct the impact tests discussed herein. A detailed view of the adapter 103 is illustrated in FIG. 2. A side view of the headform 100 with the attached adapter 103 is illustrated in FIG. 3.

The adapter 103 can include mounting holes 212A-212C, which can receive fasteners 112A-112C located within the headform 100, to secure the headform 100 to the adapter 103. As such, the adapter 103 can improve the anatomical accuracy of the location of the center of gravity 116 of the headform 100. A bore 206 in the adapter 103 and opening 301 (shown in FIG. 3) in the headform 100 can be matched to receive the occipital condyle pin 106. An opening 209 in the adapter 103 can be used to connect the neck 115 to the headform 100. The adapter 103, through the mounting holes 212A-212C and the fasteners 112A-112C, enable the headform 100 to be secured in a position that allows impact testing of helmets (e.g., equestrian helmets, hard hats or construction safety helmets) used for sports, such as for equestrian sports or related activities. The headform 100 can include various types of dummy headforms, such as the NOCSAE® headform, that are suitable for fitting equestrian helmets. The neck 115 can include various types of dummy necks, such as the Hybrid III 50^{th} percentile male neck, that can be attached to the headform 100 and is suitable for impact testing of helmets.

The sensor package 118 can be attached near the center of gravity 116 of the headform 100. The sensor package 118 can include multiple accelerometers, angular rate sensors, or other inertial measurement or sensor units that measure linear acceleration, angular velocity, angular acceleration, and other inertial metrics generated by head impacts during testing of helmets, such as equestrian helmets. In some embodiments, the sensor package 118 can include a six degree of freedom (6DoF) sensor package that includes three accelerometers and a triaxial angular rate sensor. However, other quantities and combinations of linear accelerometers, angular accelerometers, and angular rate sensors can be employed within the headform 100 to measure linear acceleration, angular velocity, and/or angular acceleration. In some cases, angular acceleration values may be determined based on the angular velocity data.

The sensor package 118 can be embodied as one or more accelerometers. As one example, the sensor package 118 is capable of measuring acceleration (i.e., the rate of change of velocity) as compared to its own instantaneous rest frame and provide feedback signals or data representative of the acceleration. The accelerometers of the sensor package 118 can be single or multi-axis accelerometers, capable of detecting both the magnitude and the direction of the acceleration in some cases, as a vector quantity. In some cases, the sensor package 118 can be an inertial measurement unit (IMU) capable of also measuring orientation, positional angular information, velocity, and other inertial information related to the headform 100. Thus, the sensor package 118 can also sense orientation, coordinate acceleration, vibration, shock, and falling motions in some cases. Examples of the accelerometers of the sensor package 118 can include accelerometers from Endevco®, Piezotronics®, Dytran®, Honeywell®, Bosch®, and other manufacturers.

The sensor package 118 can be in data communication with computing device 121. The computing device 121 can include one or more processing circuits, for example, having processors and memories or memory devices, which can be coupled to a local interface for data communication. The processing circuits of the computing device 121 can process data, as described herein, such as linear acceleration data, angular velocity data, angular acceleration data, and other types of data. In some cases, the computing device 121 can include data sampling, filtering, and processing devices or systems, for processing data from the sensor package 118. The computing device 121 can also include power sources, such as batteries or other power sources. The local interfaces of the computing device 121 can be embodied as wired, wireless, or wired and wireless local interfaces. The sensor package 118 may communicate with the computing device 121 through one or more wired, WiFi, Bluetooth®, near-field communication (NFC), radio-frequency identification (RFID), wireless infrared, ultra-wideband, wireless induction, long range (LoRa), Z-Wave®, ZigBee®, etc., interfaces.

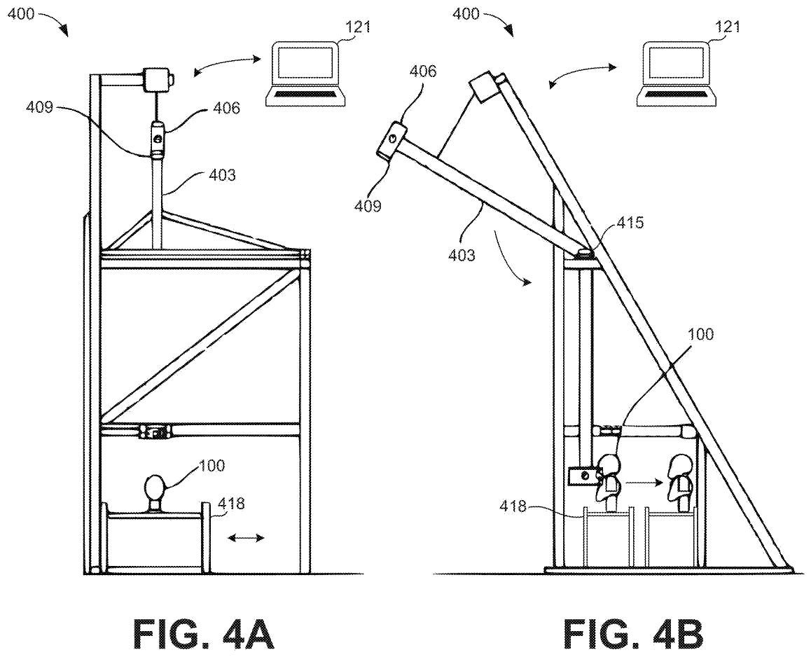

FIGS. 4A-4B illustrate various views of a pendulum impact testing apparatus 400 that can be used to impact the headform 100 during impact testing of helmets. As discussed previously, the testing methods described herein incorporate impact testing of helmets and use of a concussion risk function to analyze linear acceleration and rotational velocity values resulting from the impact tests. The pendulum impact testing apparatus 400, as illustrated in FIGS. 4A-4B and described below, is provided as a representative example. Other impact testing apparatuses can be used to implement the evaluation approaches described herein. For example, the shapes, sizes, and weights of the testing apparatus 400 can vary as compared to those described below.

The pendulum impact testing apparatus 400 includes a movable arm 403, an impactor 406, an impactor face 409, a pivot point 415, and a sliding mass 418. The pendulum impact testing apparatus 400 can be used to conduct the impact testing portion of the testing methods. Use of the pendulum impact testing apparatus 400 is beneficial in that it enables an easily repeatable system to conduct the impact tests.

In one embodiment, the movable arm 403 can be composed of a 10.16 centimeter (cm)×5.8 cm rectangular aluminum tubing, with the impactor 406 having a mass of 16.3 kilograms (kg). The length of the arm 403 from the center of the pivot point 415 to the center of the impactor 406 can be 190.5 cm. The arm 403 can have a total mass of 36.3 kg and a moment of inertia of 72 kg meter² (n²). The impactor face 409 can be flat, constructed of nylon, and have a diameter of 20.3 cm. The impactor face 409 can be designed to mimic different types of ground surfaces on which equestrian activities are commonly performed, which can maximize repeatability and reproducibility of the impact tests. Examples of such different types of ground surfaces can include sand, raked sand, dirt, raked dirt, smoothed dirt, raked and smoothed dirt, grass, artificial grass, and artificial turf. The pendulum impact testing apparatus 400 can be controlled by a winch system equipped with an electromagnet attached to the arm 403 in order to raise and release it at desired angles correlated with various velocities. In some cases, the winch system may be pneumatically or hydraulicly driven. Other pendulum impact testing apparatuses and related impact testing tools can be relied upon to gather impact data for evaluation using the concussion risk functions described herein.

In addition, components of the impact testing apparatus 400 may be controlled or directed, at least in part, by the computing device 121. For example, the computing device 121 may be in data communication with the winch system to control the angle and velocity at which the impactor 406 impacts an equestrian helmet on the headform 100 using electromechanical actuators, switches, motors, and other systems. The impact testing apparatus 400 may communicate with the computing device 121 through one or more wired, WiFi, Bluetooth®, near-field communication (NFC), radio-frequency identification (RFID), wireless infrared, ultra wideband, wireless induction, long range (LoRa), Z-Wave®, ZigBee®, etc., interfaces. According to one embodiment, the pendulum impact testing apparatus 400 can be configured so that the impactor face 409 strikes an equestrian helmet on the headform 100 at either 5.0 meters/second (m/s) or 6.3 m/s.

In order to carry out the impact tests, a helmet is first positioned on the headform 100. As discussed previously, the headform 100 and the neck 115 can include a NOCSAE® headform and a Hybrid III 50^{th} percentile male neck, respectively. The NOCSAE® headform can be mounted to the Hybrid III 50^{th} percentile male neck using the adapter 103, which provides anatomically accurate relative locations of the occipital condyle pin 106 and the center of gravity 116 of the headform 100. The headform 100 and the neck 115 are then positioned on the sliding mass 418. The sliding mass 418 can be designed to simulate the effective torso mass of a 50^{th} percentile male during a head impact according to one example, thereby increasing the biofidelity of the impact configuration. In one example, the sliding mass 418 can be mounted to an adjustable table commonly used for impact testing.

The impactor 406 provides an impacting mass that is adjustable to emulate a full range of head impact characteristics experienced by individuals, such as participants in equestrian or related activities. In this regard, the impactor face 409 may be of a certain shape, size, and weight that emulates characteristics of the aforementioned example ground surfaces equestrian participants may frequently come into contact with to cause injury. In some cases, the impactor face 409 may be flat to emulate the shape of a ground surface such as dirt or sand, since many injuries caused in equestrian sports involve head contact with the ground. When activated, the arm 403 pivots from the pivot point 415 causing the impactor face 409 to strike the helmet on the headform 100.

FIG. 4A illustrates the pendulum impact testing apparatus 400 in its resting position before activation. The arm 403 has not yet been activated, and the headform 100 positioned on the sliding mass 418 is in its starting position. FIG. 4B illustrates the pendulum impact testing apparatus 400 that has been activated. In some cases, the pendulum impact testing apparatus 400 can be controlled by the computing device 121, allowing for the velocity and angle of impact to be configured in an automated fashion based on control of a user interface of the computing device 121. In some cases, the pendulum impact testing apparatus 400 may be manually configured by a user (e.g., user who controls the winch system). When the arm 403 pivots from the pivot point 415 and the impactor surface 409 strikes the helmet on the headform 100, the sliding mass 418 and the headform 100 may change positions as depicted.

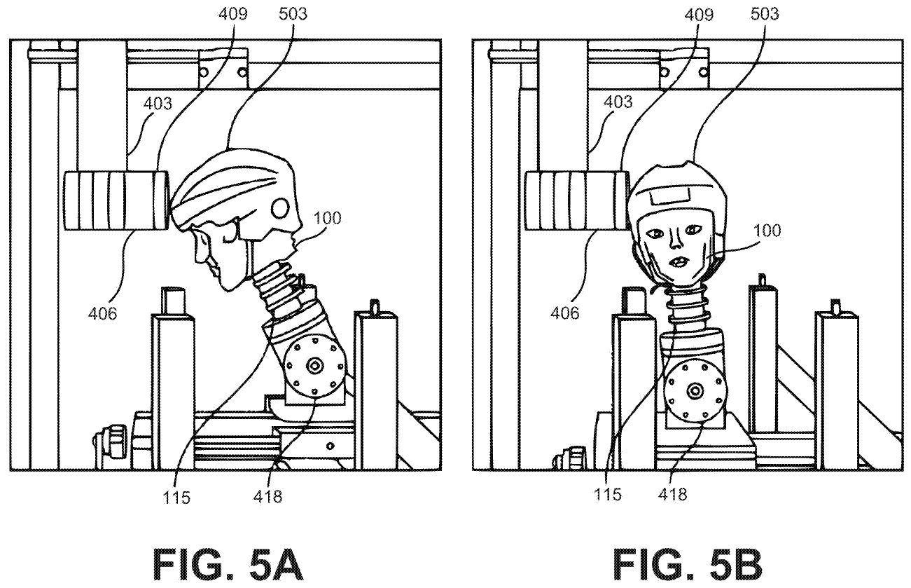

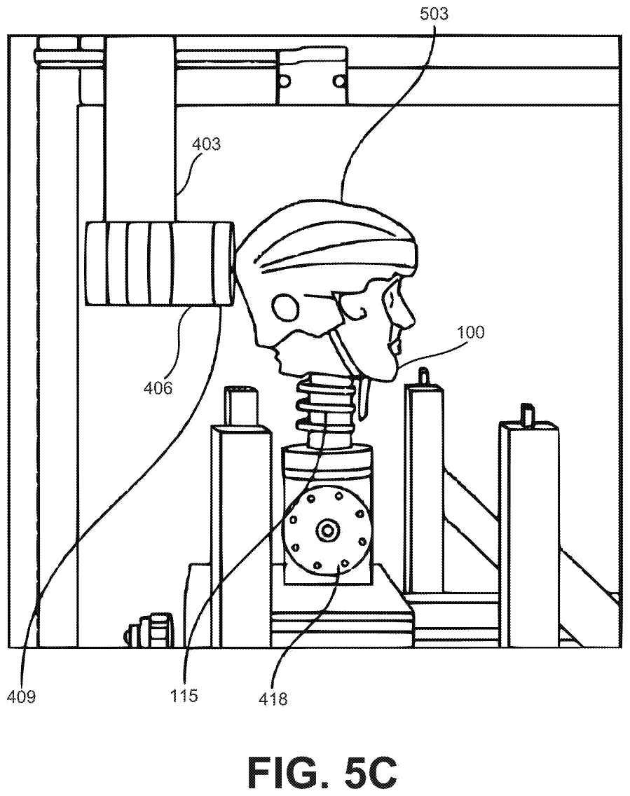

FIGS. 5A-5C illustrate a close-up view of the impactor face 409 striking various locations of a helmet 503 positioned on the headform 100. The helmet 503 can include any helmet that is used for sports or other activities requiring protective head equipment, such as for equestrian activities (e.g., cross country, show jumping, and dressage). In this respect, the helmet 503 includes various models of equestrian helmets marketed for equestrian use.

The methods described herein, for use with equestrian helmets, rely upon impact tests conducted at multiple locations of the helmet 503. In one embodiment, two impact configurations that each have three testing configurations can be used to test the model of the helmet 503. Each of the three testing configurations includes a certain combination of one of three different impact locations of the helmet 503 and one of two different impact velocities. The three different locations include a front of the helmet 503, a side of the helmet 503, and a rear of the helmet 503. The two different velocities are configurable by the user but were selected as 5.0 m/s and 6.3 m/s, in one example, for testing of equestrian helmets to respectively replicate a medium and high energy impact according to one experiment that was conducted. Other impact velocities can be relied upon in some cases.

To generate accurate test results, each impact location of the helmet 503 may be impacted only once. That is, to apply the two impact configurations to the helmet 503, which requires a total of six impacts (i.e., three impacts at a first impact velocity and three impacts at a second impact velocity), a second helmet of the same model as the helmet 503 can be used. Thus, the helmet 503 can be impact tested according to one of the two impact configurations and the second helmet can be impact tested according to the other of the two impact configurations. Each impact location being impacted only once may ensure that any deformation caused by testing does not affect any future tests.

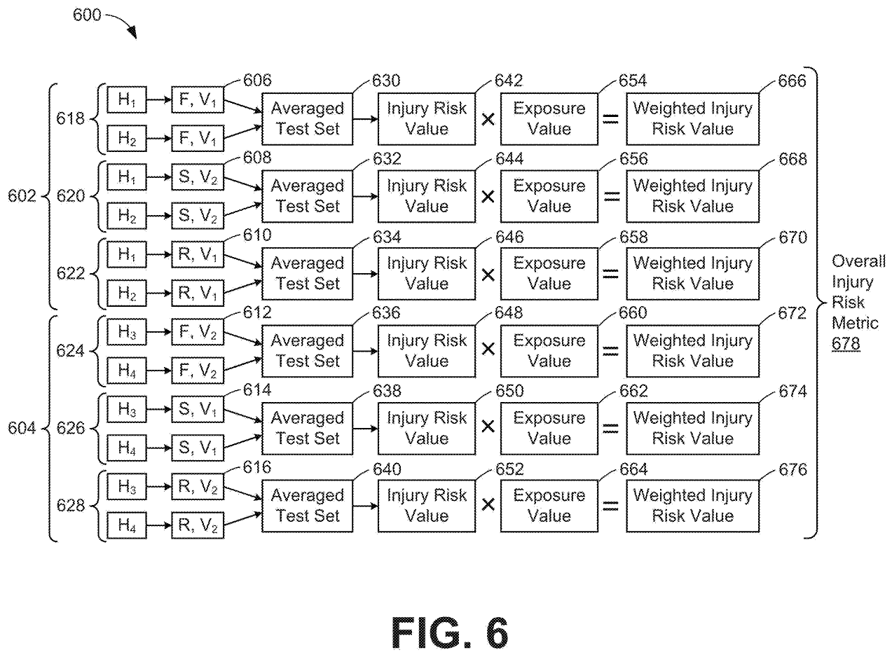

Additionally, to further augment the accuracy of the test results and evaluation of the helmet 503, each of the two impact configurations can be duplicated using a third and a fourth helmet that are each of the same model as the helmet 503. For instance, the third helmet can be impact tested according to one of the two impact configurations and the fourth helmet can be impact tested according to the other of the two impact configurations. In particular, in this example, the third helmet can be impact tested according to the three testing configurations of one of the two impact configurations and the fourth helmet can be impact tested according to the three testing configurations of the other of the two impact configurations. Duplicating the two impact configurations using four different helmets of the same model as the helmet 503 provides a larger amount of test data for a particular model of helmet, which facilitates more accurate evaluation of the helmet 503 according to examples described herein. In one example, impact algorithm 600 described herein and illustrated in FIG. 6 can be implemented to duplicate the two impact configurations using four different helmets of the same model as the model helmet 503.

FIG. 6 illustrates an example impact algorithm 600 in accordance with various embodiments of the present disclosure. The impact algorithm 600 includes a first impact configuration 602 that can be applied to the helmet 503 (“H₁” in FIG. 6) and a second helmet (“H₂”) that is a same model as the helmet 503. The impact algorithm 600 also includes a second impact configuration 604 that can be applied to a third helmet (“H₃”) and a fourth helmet (“H₄”) that are each of the same model as the helmet 503.

In the example depicted in FIG. 6, the first and second impact configurations 602, 604 collectively include testing configurations 606, 608, 610, 612, 614, 616. Each of the testing configurations 606, 608, 610, 612, 614, 616 includes a single impact to either a front (“F”), a side (“S”), or a rear (“R”) of a helmet at a first velocity (“V₁”) such as, for instance, approximately 5.0 m/s or a second velocity (“V₂”) such as, for instance, approximately 6.3 m/s. In this example, each of the testing configurations 606, 608, 610, 612, 614, 616 is duplicated using the helmet 503 (“H₁”), the second helmet (“H₂”), the third helmet (“H₃”), and the fourth helmet (“H₄”).

In the example illustrated in FIG. 6, the testing configuration 606 is duplicated by separately applying a single impact of a first pair of single impacts 618 to a front (“F”) of each of the helmet 503 (“H₁”) and the second helmet (“H₂”) at the first velocity (“V₁”). The testing configuration 608 is duplicated in this example by separately applying a single impact of a second pair of single impacts 620 to a side (“S”) of each of the helmet 503 (“H₁”) and the second helmet (“H₂”) at the second velocity (“V₂”). The testing configuration 610 is duplicated in this example by separately applying a single impact of a third pair of single impacts 622 to a rear (“R”) of each of the helmet 503 (“H₁”) and the second helmet (“H₂”) at the first velocity (“V₁”).

Additionally, in the example illustrated in FIG. 6, the testing configuration 612 is duplicated by separately applying a single impact of a fourth pair of single impacts 624 to a front (“F”) of each of the third helmet (“H₃”) and the fourth helmet (“H₄”) at the second velocity (“V₂”). The testing configuration 614 is duplicated in this example by separately applying a single impact of a fifth pair of single impacts 626 to a side (“S”) of each of the third helmet (“H₃”) and the fourth helmet (“H₄”) at the first velocity (“V₁”). The testing configuration 616 is duplicated in this example by separately applying a single impact of a sixth pair of single impacts 628 to a rear (“R”) of each of the third helmet (“H₃”) and the fourth helmet (“H₄”) at the second velocity (“V₂”).

With the testing configurations 606, 608, 610, 612, 614, 616 occurring at multiple locations on the helmet 503, FIGS. 5A-5C depict the impactor face 409 impacting the front, the side, and the rear of the helmet 503, respectively. FIGS. 5A-5C also serve as illustrative examples of the aforementioned duplications of the testing configurations 606, 608, 610, 612, 614, 616. That is, FIGS. 5A-5C also serve as illustrative examples of the impactor face 409 impacting the front, the side, and the rear, respectively, of the second helmet (“H₂”), the third helmet (“H₃”), and the fourth helmet (“H₄”). When the helmet 503 (“H₁”), the second helmet (“H₂”), the third helmet (“H₃”), and the fourth helmet (“H₄”) are respectively impacted, resultant linear and angular accelerations are generated by the sensor package 118 based on translations and rotations of the headform 100 on the sliding mass 418. In the example illustrated in FIG. 6, the resultant linear and angular acceleration values that are respectively generated for each of the pairs of single impacts 618, 620, 622, 624, 626, 628 are respectively averaged to obtain averaged test sets 630, 632, 634, 636, 638, 640. Each of the averaged test sets 630, 632, 634, 636, 638, 640 includes an averaged linear acceleration value and an averaged angular acceleration value resulting from the respective duplicated application of each of the testing configurations 606, 608, 610, 612, 614, 616.

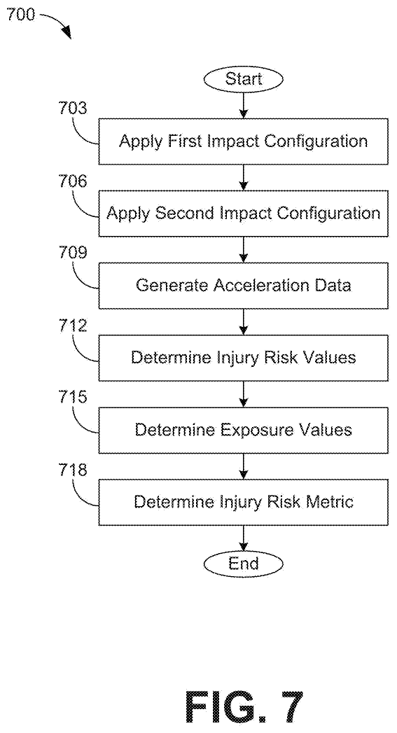

In the example depicted in FIG. 6, the averaged test sets 630, 632, 634, 636, 638, 640 are then used to respectively calculate concussion (injury) risk values 642, 644, 646, 648, 650, 652 for the testing configurations 606, 608, 610, 612, 614, 616 by using a concussion risk function described herein with reference to FIG. 7. That is, the concussion risk function denoted herein as “Eq. 1” and described with reference to FIG. 7 is then used to respectively calculate injury risk values 642, 644, 646, 648, 650, 652 based on the averaged test sets 630, 632, 634, 636, 638, 640.

In the example depicted in FIG. 6, the injury risk values 642, 644, 646, 648, 650, 652 are then respectively multiplied by an exposure value 654, 656, 658, 660, 662, 664 to respectively obtain weighted concussion (injury) risk values 666, 668, 670, 672, 674, 676. The exposure values 654, 656, 658, 660, 662, 664 are determined based on and correspond to the respective impact locations of the testing configurations 606, 608, 610, 612, 614, 616. In this example, the exposure values 654, 660 each correspond to a front (“F”) impact location and are each equivalent to a value of one, although another value can be used in some cases. In this example, the exposure values 656, 662 each correspond to a side (“S”) impact location and are each equivalent to a value of two, although another value can be used in some cases. In this example, the exposure values 658, 664 each correspond to a rear (“R”) impact location and are each equivalent to a value of three, although another value can be used in some cases. The exposure values 654, 656, 658, 660, 662, 664 each denote a relative frequency of impact that could respectively occur at the front, the side, and the rear of the helmet 503. In this example, the weighted injury risk values 666, 668, 670, 672, 674, 676 are then aggregated (i.e., added, summed, totaled) to determine an overall concussion (injury) risk metric 678 for the helmet 503.

The impactor face 409 is flat to simulate a ground surface such as dirt or sand, since many injuries caused in equestrian sports involve head contact with the ground. However, other impactor surfaces of a different shape, weight, and surface can be used to simulate other injury contact surfaces that may be prevalent in an equestrian activity (e.g., cross country, show jumping, and dressage). In some embodiments, fewer or greater than two impact configurations, six testing configurations, three impact locations, and two impact velocities may be used to conduct impact testing of the helmet 503. That is, any one of the three aforementioned impact locations may or may not be impacted, one or both of the different impact velocities may or may not be used, and a second, third, and fourth helmet of the same model as the helmet 503 may or may not be used. In some cases, more than four helmets of the same model may be tested.

In some examples, the impact algorithm 600 and the equipment used to implement the impact algorithm 600 can be defined and selected, respectively, as described in Appendix A of U.S. Provisional Application Ser. No. 63/370,019 and as described in U.S. Non-Provisional application Ser. No. 18/363,293, the entire contents of which are incorporated herein. In one example, the exposure values 654, 656, 658, 660, 662, 664 can be determined as described in Part 1, titled “Video Analysis of Equestrian Falls” of each of the “Methods” and “Results” sections of Appendix A included with U.S. Provisional Application Ser. No. 63/370,019 (“the '019 Application”), the entire contents of which is incorporated herein. In another example, the pendulum impact testing apparatus 400 can be selected to perform various impact testing described herein based on the in-field and in-lab experimentation and analysis described in Parts 2 and 3, respectively titled “Laboratory System Comparison” and “Onsite Field Testing” of each of the “Methods” and “Results” sections of Appendix A in the '019 Application. In another example, the impactor face 409 can be selected as a flat surface based on the in-lab experimentation and analysis described in Part 4, titled “Laboratory Impactor Surface Comparison” of each of the “Methods” and “Results” sections of Appendix A in the '019 Application.

The different first and second impact velocities (“V₁” and “V₂”) can be selected to replicate a medium and high energy impact, respectively, where the medium energy impact corresponds to a medium fall height and the high energy impact corresponds to a high fall height. In one example, the first and second impact velocities (“V₁” and “V₂”) can be selected as described in Appendix A in the '019 Application. Although a velocity of approximately 5.0 m/s is used herein to represent a medium energy impact and a velocity of approximately 6.3 m/s is used herein to represent a high energy impact, other impact velocities can also be relied upon. In some cases, a velocity of greater than 6.3 m/s may be selected to replicate a high energy impact, and a velocity of lower than 5.0 m/s may be selected to replicate a medium energy impact.

Each impact location being tested once is an important consideration that can be factored in when applying the concussion risk function, which will be discussed in detail in the following paragraphs with respect to the flowchart shown in FIG. 7. In addition, as most, if not all, equestrian helmets can only provide protection against one relatively major impact, the three impact locations (i.e., the front, the side, and the rear) are impacted only once for a given equestrian helmet in accordance with the methods described herein.

FIG. 7 is a flowchart outlining the steps of a method 700 for evaluating the concussion mitigation performance of helmets (e.g., equestrian helmets, hard hats or construction safety helmets) or protective head gear used in sports or similar activities. In one example, the method 700 can be implemented according to the impact algorithm 600 described herein with reference to FIG. 6.

At box 703, a first impact configuration is applied to a helmet that is selected for testing. For example, with reference to FIGS. 4A-5C and FIG. 6, the helmet 503 can be tested for concussion mitigation performance by using two helmets of the same model as the helmet 503 to duplicate the first impact configuration at box 703. That is, as described herein with reference to FIG. 6, the helmet 503 (“H₁”) and the second helmet (“H₂”) can be used to duplicate each of the testing configurations 606, 608, 610 of the first impact configuration 602. At box 703, the helmet 503 (“H₁”) and the second helmet (“H₂”) of the same model as the helmet 503, are individually positioned on the headform 100 based on the helmet manufacturer's fitting guidelines. The headform 100 can be mounted to the neck 115 using the adapter 103. The headform 100 and the neck 115 can be mounted to the sliding mass 418 and can be positioned within an impact area of the pendulum impact testing apparatus 400.

The first impact configuration at box 703 can include impacts to multiple locations on each of the helmet 503 (“H₁”) and the second helmet (“H₂”), using either a first or a second impact velocity at each of such locations. For example, with reference to FIG. 6, the first impact configuration at box 703 can be implemented as the first impact configuration 602, which includes the testing configurations 606, 608, 610. Each of the testing configurations 606, 608, 610 includes a single impact to either a front (“F”), a side (“S”), or a rear (“R”) of a helmet at a first velocity (“V₁”) such as, for instance, approximately 5.0 m/s or a second velocity (“V₂”) such as, for instance, approximately 6.3 m/s. In this example, each of the testing configurations 606, 608, 610 can be duplicated at box 703 using the helmet 503 (“H₁”) and the second helmet (“H₂”) as illustrated in FIG. 6.

For instance, at box 703, the testing configuration 606 can be duplicated by separately applying a single impact of the first pair of single impacts 618 to a front (“F”) of each of the helmet 503 (“H₁”) and the second helmet (“H₂”) at the first velocity (“V₁”). The testing configuration 608 can be duplicated in this example by separately applying a single impact of the second pair of single impacts 620 to a side (“S”) of each of the helmet 503 (“H₁”) and the second helmet (“H₂”) at the second velocity (“V₂”). The testing configuration 610 can be duplicated in this example by separately applying a single impact of the third pair of single impacts 622 to a rear (“R”) of each of the helmet 503 (“H₁”) and the second helmet (“H₂”) at the first velocity (“V₁”).

In accordance with one example, as shown in FIGS. 5A-5C, the pendulum impact testing apparatus 400 and the headform 100 can be configured so that the impactor 406 respectively impacts the front, the side, and the rear of each of the helmet 503 (“H₁”) and the second helmet (“H₂”), for a total of three impact locations and six individually applied impacts. However, other locations on each of the helmet 503 (“H₁”) and the second helmet (“H₂”) may be impacted in some cases. In some cases, the pendulum impact testing apparatus 400 can be controlled by a winch system equipped with an electromagnet in order to raise and release the movable arm 403 at desired angles corresponding to a desired impact velocity. In some cases, the winch system may be pneumatically or hydraulicly driven. In some cases, the pendulum impact testing apparatus 400 may also be controlled by the computing device 121.

At box 706, a second impact configuration is applied to a helmet that is selected for testing. For example, with reference to FIGS. 4A-5C and FIG. 6, the helmet 503 can be tested for concussion mitigation performance by using two helmets of the same model as the helmet 503 to duplicate the second impact configuration at box 706. That is, as described herein with reference to FIG. 6, the third helmet (“H₃”) and the fourth helmet (“H₄”) can be used to duplicate each of the testing configurations 612, 614, 616 of the second impact configuration 604. At box 706, the third helmet (“H₃”) and the fourth helmet (“H₄”), which are each of the same model as the helmet 503, are individually positioned on the headform 100 based on the helmet manufacturer's fitting guidelines. The headform 100 can be mounted to the neck 115 using the adapter 103. The headform 100 and the neck 115 can be mounted to the sliding mass 418 and can be positioned within an impact area of the pendulum impact testing apparatus 400.

The second impact configuration at box 706 can include impacts to multiple locations on each of the third helmet (“H₃”) and the fourth helmet (“H₄”), using either a first or a second impact velocity at each of such locations. For example, with reference to FIG. 6, the second impact configuration at box 706 can be implemented as the second impact configuration 604, which includes the testing configurations 612, 614, 616. Each of the testing configurations 612, 614, 616 includes a single impact to either a front (“F”), a side (“S”), or a rear (“R”) of a helmet at a first velocity (“V₁”) such as, for instance, approximately 5.0 m/s or a second velocity (“V₂”) such as, for instance, approximately 6.3 m/s. In this example, each of the testing configurations 612, 614, 616 can be duplicated at box 706 using the third helmet (“H₃”) and the fourth helmet (“H₄”) as illustrated in FIG. 6.

For instance, at box 706, the testing configuration 612 can be duplicated by separately applying a single impact of the fourth pair of single impacts 624 to a front (“F”) of each of the third helmet (“H₃”) and the fourth helmet (“H₄”) at the second velocity (“V₂”). The testing configuration 614 can be duplicated in this example by separately applying a single impact of the fifth pair of single impacts 626 to a side (“S”) of each of the third helmet (“H₃”) and the fourth helmet (“H₄”) at the first velocity (“V₁”). The testing configuration 616 can be duplicated in this example by separately applying a single impact of the sixth pair of single impacts 628 to a rear (“R”) of each of the third helmet (“H₃”) and the fourth helmet (“H₄”) at the second velocity (“V₂”).

In accordance with one example, as shown in FIGS. 5A-5C, the pendulum impact testing apparatus 400 and the headform 100 can be configured so that the impactor 406 respectively impacts the front, the side, and the rear of each of the third helmet (“H₃”) and the fourth helmet (“H₄”), for a total of three impact locations and six individually applied impacts. However, other locations on each of the third helmet (“H₃”) and the fourth helmet (“H₄”) may be impacted in some cases. In some cases, the pendulum impact testing apparatus 400 can be controlled by a winch system equipped with an electromagnet in order to raise and release the movable arm 403 at desired angles corresponding to a desired impact velocity. In some cases, the winch system may be pneumatically or hydraulicly driven. In some cases, the pendulum impact testing apparatus 400 may also be controlled by the computing device 121.

At box 709, acceleration data is generated by various accelerometers and sensors that can be positioned within a headform that is being used for impact testing. For example, the sensor package 118, which is positioned within the headform 100 near the center of gravity 116, may include accelerometers and angular rate sensors, among other IMUs. In one embodiment, the sensor package 118 includes a six degree of freedom (6DoF) sensor package that includes three accelerometers and a triaxial angular rate sensor. The three accelerometers can measure linear acceleration data, whereas the triaxial angular rate sensor may measure angular velocity data. In some embodiments, the sensor package 118 may also include angular accelerometers configured to measure angular acceleration, and also a different quantity of accelerometers and/or angular rate sensors.

The computing device 121 may receive the generated data, including the acceleration data and angular velocity data, among other inertial measurement data, and process it as described herein. In cases where angular acceleration is not measured, the computing device 121 may determine the angular acceleration values based on differentiating the angular velocity data. According to one example, the acceleration data and angular velocity data measured for each of the twelve impacts of the impact algorithm 600 and the method 700 can be sampled by the computing device 121 at 20,000 Hertz (Hz) and further filtered by the computing device 121 using a 4-pole Butterworth low pass filter according to SAE J211 (Instrumentation for Impact Test), with a cutoff frequency of 1650 Hz (CFC 1000) for the accelerometer data and 256 Hz (CFC 155) for the angular rate sensor data. In this example, the angular acceleration values can be determined by the computing device 121 by differentiating the angular rate data. Resultant values can then be calculated by the computing device 121 for linear acceleration (denoted in units of grams (g)) and angular acceleration (denoted in units of radians/second² (rad/sec²)).

At box 709, for each impact that occurs at the aforementioned impact locations, the sensor package 118 can generate linear acceleration data, angular velocity data, angular acceleration data, and other inertial measurement data. For instance, for each single impact of each of the first, second, third, fourth, fifth, and sixth pair of single impacts 618, 620, 622, 624, 626, 628, the sensor package 118 can generate linear acceleration data, angular velocity data, angular acceleration data, and other inertial measurement data. In this example, the computing device 121 can then respectively average the linear and angular acceleration data obtained from each of the first, second, third, fourth, fifth, and sixth pair of single impacts 618, 620, 622, 624, 626, 628, to generate the averaged test sets 630, 632, 634, 636, 638, 640.

At box 712, the linear and angular acceleration values generated at box 709 may be used by the computing device 121 to determine concussion (injury) risk values. For example, the averaged test sets 630, 632, 634, 636, 638, 640 generated at box 709 can be used by the computing device 121 to determine the injury risk values 642, 644, 646, 648, 650, 652 corresponding to the testing configurations 606, 608, 610, 612, 614, 616, respectively. For each of the testing configurations 606, 608, 610, 612, 614, 616 applied at boxes 703 and 706, the computing device 121 is configured to calculate a respective injury risk value 642, 644, 646, 648, 650, 652 based on the following function or equation, Equation 1 (Eq. 1):

$$R ( a , ∝ ) = \frac{1}{1 + {e}^{- ( - 10.2 + 0.0433 * a + 0.000873 * ∝ - 9.2 \times {10}^{- 7} * a ∝ )}} \qquad Eq . 1$$

This equation, also referenced herein as the injury risk function or concussion risk function, outputs a respective injury risk value 642, 644, 646, 648, 650, 652 based on each corresponding averaged test set 630, 632, 634, 636, 638, 640, which respectively include an averaged resultant linear acceleration value (a) and an averaged resultant angular acceleration value (∝). The concussion risk function includes use of both linear and angular acceleration data because they are both correlated and predictive of concussion. A multivariate logistic regression analysis can be used to model risk as a function of both linear and angular head acceleration. Using the concussion risk function enhances the data analysis by increasing the importance of higher acceleration impacts.

At box 715, exposure values are determined for each impact that occurs as part of the overall impact test. For example, exposure values can be determined based on the respective impact locations of each impact of the testing configurations 606, 608, 610, 612, 614, 616 applied at box 703 and 706. In one example, the exposure values 654, 656, 658, 660, 662, 664 can be determined at box 715 based on the respective impact locations of each impact of the testing configurations 606, 608, 610, 612, 614, 616. In this example, the exposure values 654, 660 each correspond to a front (“F”) impact location and are each equivalent to a value of one. In this example, the exposure values 656, 662 each correspond to a side (“S”) impact location and are each equivalent to a value of two. In this example, the exposure values 658, 664 each correspond to a rear (“R”) impact location and are each equivalent to a value of three.

The exposure values 654, 656, 658, 660, 662, 664 each denote a relative frequency of impact that could respectively occur at the front, the side, and the rear of the helmet 503. The relative frequency of impact can be approximated based on historical equestrian fall data that includes a plurality of equestrian falls resulting in various impacts to different locations on equestrian helmets. By determining how often certain locations of an equestrian helmet are impacted over a given number of equestrian falls, a relative frequency of impact to each of such locations can be approximated and thereafter serve as an exposure value. In some cases, the exposure values described herein can be denoted as a whole number. In these cases, a lower exposure value can correspond to a location on equestrian helmets where impacts have been observed to occur relatively less frequently, whereas a higher exposure value can correspond to a location on equestrian helmets where impacts have been observed to occur relatively more frequently. In one example, the exposure values 654, 656, 658, 660, 662, 664 can be determined as described in Part 1, titled “Video Analysis of Equestrian Falls” of each of the “Methods” and “Results” sections of Appendix A in the '019 Application.

Further, most, if not all, equestrian helmets can only provide protection against one relatively major impact. As such, the three impact locations (i.e., the front, the side, and the rear) are impacted only once for a given equestrian helmet in accordance with the impact algorithm 600 and the method 700.

At box 718, a concussion (injury) risk metric is determined for a helmet model based on the exposure values determined at box 715 and the concussion (injury) risk values determined at box 712. The concussion risk metric (also referred to herein as “injury risk metric” or “overall injury risk metric”) is determined based on Equation 2 (Eq. 2) defined below:

$$Equestrian {STAR}_{pendulum} = {\sum }_{L = 1}^{3} {\sum }_{V = 1}^{2} E ( L , V ) * R ( a , ∝ ) , \qquad Eq . 2$$

where E represents exposure, L represents impact locations, V represents impact velocity, and R represents concussion risk. With reference to the testing configurations 606, 608, 610, 612, 614, 616 applied at box 703 and 706, by using Eq. 2, individual concussion risk values determined at box 712 for each of these six testing configurations are multiplied by corresponding exposure values determined at box 715. Based on such respective multiplication, corresponding weighted concussion risk values can be obtained. For instance, with reference to FIG. 6, by using Eq. 2, the injury risk values 642, 644, 646, 648, 650, 652 can be respectively multiplied by the exposure values 654, 656, 658, 660, 662, 664 to respectively obtain the weighted concussion (injury) risk values 666, 668, 670, 672, 674, 676. In this example, by using Eq. 2, the weighted concussion (injury) risk values 666, 668, 670, 672, 674, 676 can then be summated together to generate an overall score, such as an overall injury risk metric 678, which can denote a STAR score. In some embodiments, the computing device 121 may perform the steps 712-718 to determine the STAR score for a given helmet model.

The STAR score for a given helmet model is then used to determine a corresponding rating or STAR rating. The STAR score is different from the STAR rating. Lower STAR scores may represent a lower risk of concussion and may be assigned to higher STAR ratings. The STAR rating may range up to five stars for the best available helmets. To provide a useful tool for consumers to make informed decisions, the STAR scores for each helmet can be used to create a STAR rating system having a STAR rating for each helmet tested according to the example methods described herein. Each STAR rating of the STAR rating system can range from five stars for the best performing helmets to one star for the lowest performing helmets.

The high risk of head injury across the majority of equestrian helmets could be responsible for the high head injury rates observed in equestrian activities such as cross country, show jumping, and dressage. The equestrian helmets should reduce the head impact accelerations much more across all helmets to potentially reduce the number of injuries in equestrian sports. In some cases, only a single size of the helmet 503 is tested according to at least one of the impact algorithm 600 or the method 700. Such testing conditions assume that performance is consistent throughout each size of helmet. However, there still could be deviation in performance as size increases or decreases due to potential changes in padding configuration and thickness. Accordingly, further embodiments of the present disclosure may include testing helmets of different sizes and/or weight, with the helmets being the same model. Additional embodiments may include testing helmets designated for different genders (e.g., male or female) of the same model.

The Equestrian STAR rating systems described herein help equestrian riders understand how the available equestrian helmets compare to each other in their ability to reduce both linear and rotational head acceleration. The current standards for equestrian helmets are pass or fail only, and do not differentiate between the most and least protective helmets. By giving equestrian riders the information needed to purchase the most protective helmets, the number and severity of head injuries caused by equestrian falls has the potential to decrease. Additionally, the Equestrian STAR evaluation methods described herein will help equestrian helmet companies design safer helmets. Equestrian helmet manufacturers can use the results from the Equestrian STAR helmet ratings to determine which of their helmet designs are the most effective.

Many researchers have been using lab head impact data alongside computer models that simulate brain tissue strain. The linear and angular head acceleration data discussed herein may be utilized with computer models. This would allow for a better understanding of equestrian head injury response specifically in relation to brain deformation. Computer modeling (e.g., finite element modeling) has also been used in helmet research to design optimized helmet prototypes. These techniques could be applied in conjunction with the multimodal helmet evaluation systems and methods described herein to develop a helmet that is able to substantially reduce head injury risk.

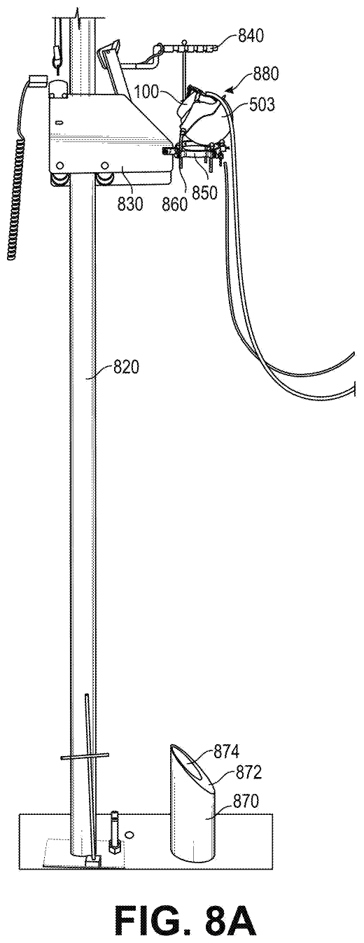

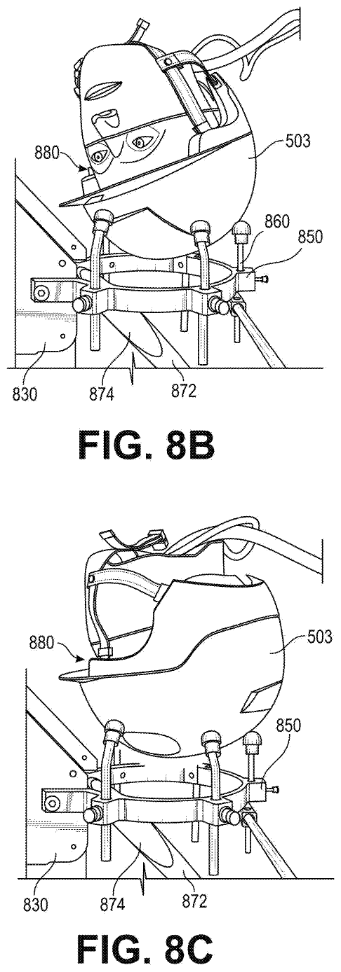

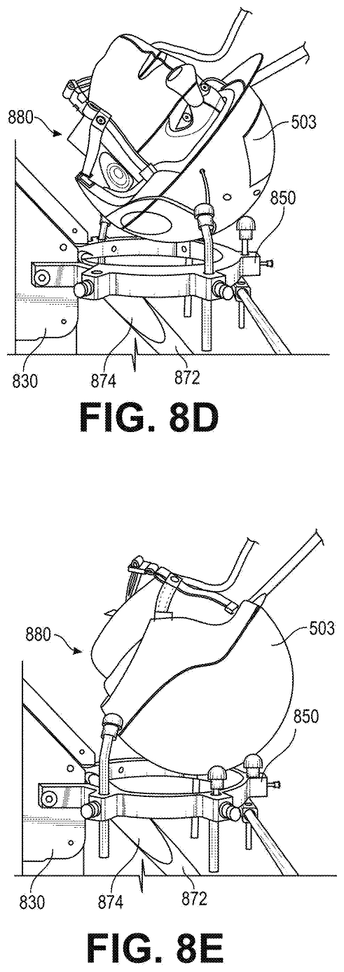

FIGS. 8A-8E illustrate various views of an oblique impact testing apparatus 800 that can be used to impact the helmet 503 and the headform 100 during oblique impact testing of helmets. FIG. 8A illustrates the oblique impact testing apparatus 800 in its resting position before activation according to various aspects and embodiments of the present disclosure. FIGS. 8B-8E illustrate views of a helmeted headform positioned in different impact positions on the oblique impact testing apparatus 800 according to various aspects and embodiments of the present disclosure. FIGS. 8B and 8C illustrate views of the helmeted headform positioned in a left and right front boss impact position, respectively, on the oblique impact testing apparatus 800. FIGS. 8D and 8E illustrate views of the helmeted headform positioned in a left and right rear boss impact position, respectively, on the oblique impact testing apparatus 800.

As discussed previously, the testing methods described herein incorporate impact testing of helmets and use of a concussion risk function to analyze linear and angular acceleration values resulting from the impact tests. The oblique impact testing apparatus 800 can be used to conduct the oblique impact testing portion of the testing methods. Use of the oblique impact testing apparatus 800 is beneficial in that it enables an easily repeatable system to conduct the oblique impact tests. For instance, the oblique impact testing apparatus 800 can be used to drop a supported helmeted 50th percentile male NOCSAE headform without a neck such as the headform 100 wearing the helmet 503 onto a 45 degree (°) steel anvil covered in 80-grit sandpaper in some cases.

Referring to FIGS. 8A-8E, among other components the oblique impact testing apparatus 800 includes a vertical guide member 820, a drop cart 830 slidably coupled to the vertical guide member 820, a lever arm 840 coupled to the drop cart 830, a support ring 850 coupled to the drop cart 830 and the lever arm 840, adjustable rods 860 adjustably coupled to the support ring 850, and an anvil 870 positioned vertically below the support ring 850.

The anvil 870 is embodied as a steel anvil having an angled surface 872 that is at least partly abrasive in the example shown. The anvil 870 in this example has a 45 degree (°) angled surface 872 and an abrasive material 874 coupled to the angled surface 872. The abrasive material 874 can be embodied as 80-grit sandpaper in many cases, although other grades of abrasion may be relied upon in some cases. The anvil 870 may also have an angled surface 872 that is greater or less than 450 in some cases.

The support ring 850 and the adjustable rods 860 are configured and operable to at least partly position, support, and fix in place a helmeted headform 880 during operation of the oblique impact testing apparatus 800. The helmeted headform 880 includes the headform 100 wearing the helmet 503. An inclinometer is coupled to the helmeted headform 880 by way of various power and signal cables as illustrated in this example.

The inclinometer is configured and operable to assess correct x and y rotation during operation of the oblique impact testing apparatus 800, and consistent z rotation can be verified with a cross-level laser and 5° increments inscribed on the support ring 850. The support ring 850 is attached to the drop cart 830 and the lever arm 840, which releases at least one of the headform 100, the helmet 503, or the helmeted headform 880 before impacting the anvil 870. During operation of the oblique impact testing apparatus 800 and immediately prior to impacting the anvil 870, the support ring 850 passes around the angled surface 872 of the anvil 870. The oblique impact testing apparatus 800 is embodied, configured, and operable to generate impacts with relative normal and tangential velocity vectors in various examples.

In some cases, the oblique impact testing apparatus 800 can be coupled to and controlled by the computing device 121 described herein with reference to FIG. 1, allowing for the velocity of oblique impact to be configured in an automated fashion based on control of a user interface of the computing device 121. In other examples, the oblique impact testing apparatus 800 may be manually configured by a user (e.g., user who controls and releases the drop cart 830 from a predetermined height to yield a defined impact velocity of 6.56 m/s in many cases).

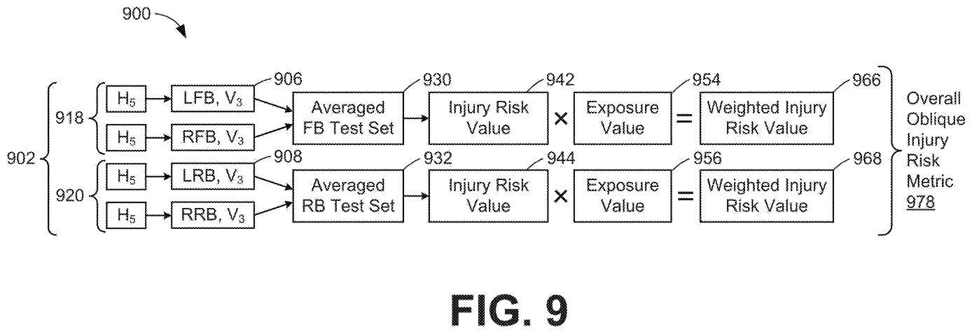

FIG. 9 illustrates an example oblique impact algorithm 900 in accordance with various aspects and embodiments of the present disclosure. The oblique impact algorithm 900 includes an oblique impact configuration 902 that can be applied to a fifth helmet (“H₅” in FIG. 9) that is a same model as the helmet 503. In the example depicted in FIG. 9, the oblique impact configuration 902 includes first and second pairs 918, 920 of single oblique impacts to a front and rear boss of the fifth helmet (“H₅”) at a third velocity (“V₃”) such as approximately 6.56 m/s. For instance, the oblique impact configuration 902 includes oblique testing configurations 906, 908. The oblique testing configuration 906 includes a single oblique impact to a left front boss (“LFB”) of the fifth helmet (“H₅”) and a single oblique impact to a right front boss (“RFB”) of the fifth helmet (“H₅”), respectively, at the third velocity (“V₃”). The oblique testing configuration 908 includes a single oblique impact to a left rear boss (“LRB”) of the fifth helmet (“H₅”) and a single oblique impact to a right rear boss (“RRB”) of the fifth helmet (“H₅”), respectively, at the third velocity (“V₃”).

In the example illustrated in FIG. 9, the resultant linear and angular acceleration values that are generated for each of the pairs 918 and 920 of single oblique impacts are then respectively averaged to obtain averaged front and rear boss test sets. For instance, the resultant linear and angular acceleration values that are generated for the pair 918 of single oblique impacts to the left and right front boss are respectively averaged to obtain averaged front boss (“FB”) test set 930, and the resultant linear and angular acceleration values that are generated for the pair 920 of single oblique impacts to the left and right rear boss are respectively averaged to obtain averaged rear boss (“RB”) test set 932. In the example shown, the averaged test set 930 includes an averaged linear acceleration value and an averaged angular acceleration value resulting from the oblique impacts to the left and right front boss of the fifth helmet (“H₅”). The averaged test set 932 includes an averaged linear acceleration value and an averaged angular acceleration value resulting from the oblique impacts to the left and right rear boss of the fifth helmet (“H₅”).

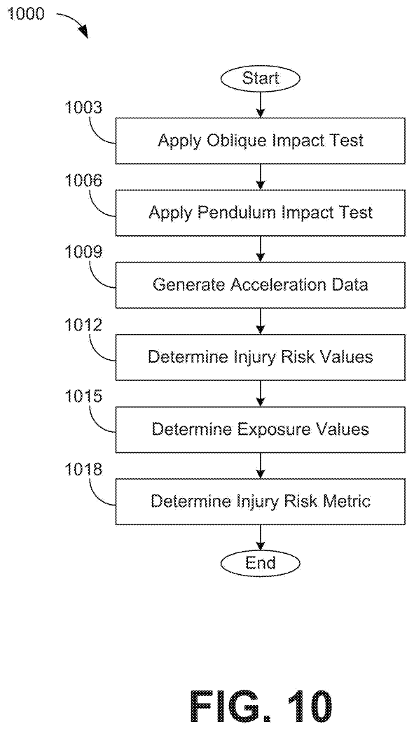

In the example depicted in FIG. 9, the averaged front and rear boss test sets 930, 932 are then used to respectively calculate concussion or injury risk values 942, 944 for the oblique testing configurations 906, 908 by using the concussion risk function Eq. 1 and other equations described herein with reference to FIGS. 7 and 10. In the example depicted in FIG. 9, the injury risk values 942, 944 are then respectively multiplied by an exposure value 954, 956 to respectively obtain weighted concussion or injury risk values 966, 968. The exposure values 954, 956 are determined based on and correspond to the respective impact locations of the oblique testing configurations 906, 908. In this example, the exposure value 954 corresponds to a front boss (“FB”) impact location and can be designated with a certain value such as 1 as described further herein. In this example, the exposure values 956 corresponds to a rear boss (“RB”) impact location and can be designated with a certain value such as 1 as described further herein. The exposure values 954, 956 each denote a relative frequency of impact that could respectively occur at the front boss and the rear boss of the helmet 503, respectively. In this example, the weighted injury risk values 966, 968 are then aggregated (i.e., added, summed, totaled) to determine an overall concussion or oblique injury risk metric 978 for the helmet 503.

Each impact location being tested once is an important consideration that can be factored in when applying the concussion risk function, which will be discussed in detail in the following paragraphs with respect to the flowchart shown in FIG. 10. In addition, as most, if not all, equestrian helmets can only provide protection against one relatively major impact, the four oblique impact locations (i.e., the left front boss, the right front boss, the left rear boss, the right rear boss) are impacted only once for a given equestrian helmet in accordance with the methods described herein.

FIG. 10 is a flowchart illustrating exemplary steps of another method 1000 to evaluate concussion mitigation performance of helmets in accordance with various aspects and embodiments of the present disclosure. The method 1000 can be implemented in many cases to evaluate the concussion mitigation performance of helmets (e.g., equestrian helmets, hard hats or construction safety helmets) or protective head gear used in sports or similar activities. In one example, the method 1000 can be implemented according to the impact algorithm 600 and the oblique impact algorithm 900 described herein with reference to FIGS. 6 and 9.

At box 1003, the method 1000 includes applying an oblique impact test to one or more helmets such as one or more of the helmet 503. In one example, oblique impact testing was performed using the oblique impact testing apparatus 800 described herein and illustrated in FIGS. 8A-8E, and the testing was completed according to the oblique impact algorithm 900 described herein and illustrated in FIG. 9. The oblique impact testing apparatus 800 was used to drop the helmeted headform 880 onto the anvil 870 in this example. The NOCSAE headform has a circumference of 57.6 centimeters (cm) according to one example, and the shape of the headform provides a realistic fit with the helmet. To ensure proper fit between the helmet 503 and the headform 100 in the helmeted headform 880, a helmet rim was positioned 2.5 cm above the brow line, the straps were secured tightly under the chin, and the adjustment dials were tightened until resistance was met. The helmeted headform 880 was held in place by the support ring 850 and positioned by the adjustable rods 860 inside the support ring 850. An inclinometer was used to assess correct x and y rotation, and consistent z rotation was verified with a cross-level laser and 5° increments inscribed on the support ring 850. The support ring 850 was attached to the drop cart 830 and the lever arm 840, which releases at least one of the headform 100, the helmet 503, or the helmeted headform 880 before impacting the anvil 870. During the impact, the support ring 850 passes around the angled anvil 870. The oblique impact testing apparatus 800 can generate impacts with relative normal and tangential velocity vectors.

In one example, four locations were assessed for oblique impact on each of the helmet 503 models: the left front boss, right front boss, left rear boss, and right rear boss (e.g., see FIGS. 8B-8E and Table 1). As each location was only impacted once, one helmet was tested for each helmet model. Data from the left and right front boss were averaged into one value for the front boss, and data from the left and right rear boss were averaged into one value for the rear boss. These locations were chosen to complement the three locations previously tested in the previous Equestrian STAR (e.g., the front, side, and back) to provide a more comprehensive evaluation of head acceleration reduction across the helmet. Both the front boss and rear boss locations were impacted at 6.56 m/s in many examples, although another velocity may be relied upon in other cases. Testing 45 equestrian helmet models under these conditions resulted in a total of 180 impact tests.

Table 1 includes data regarding NOCSAE headform rotations on the support ring 850 for each oblique impact location. X and Y rotations were determined with an inclinometer according to the SAE J211 coordinate system, and Z axis rotation was determined by projecting the midsagittal line (for front boss locations) or midcoronal line (for rear boss locations) of the headform face onto the support ring marked with 5° increments. A 0° position corresponds to the headform facing the drop tower, with positive Z values increasing in the clockwise direction and negative in the counterclockwise direction.

TABLE 1
Example NOCSAE headform rotations

| Location | | X (deg) | Y (deg) | Z (deg) |
|---|---|---|---|---|
| Front boss | Left | 15.6 | 5.7 | −80 |
| | Right | −15.6 | 5.7 | 80 |
| Rear boss | Left | 46.0 | −27.9 | 170 |
| | Right | −46.0 | −27.9 | −170 |

At box 1006, the method 1000 includes applying a pendulum impact test to one or more helmets such as one or more of the helmet 503. In one example, pendulum impact testing was performed using the pendulum impact testing apparatus 400 described herein and illustrated in FIGS. 5A-5C, and the testing was completed according to the impact algorithm 600 described herein and illustrated in FIG. 6.

In one example, oblique tests completed at box 1003 were compared to linear-driven impact tests performed in the previous Equestrian STAR testing. Helmets such as the helmet 503 were tested on the pendulum impact testing apparatus 400, which uses a pendulum arm connected to an impactor surface to induce linear-driven impacts toward headform's center of gravity. The previous Equestrian STAR testing used a flat impactor surface that was 12.7 cm wide, 2.5 cm thick, and composed of nylon. The pendulum impact testing apparatus 400 includes the same NOCSAE headform and instrumentation described for the oblique impact testing apparatus 800 in this example. The headform was mounted to a Hybrid III neck with a custom adaptor plate, which was designed to give the headform anatomically accurate locations of the headform center of gravity and occipital condyle pin. Among available options, the Hybrid III neck is the most commonly used in helmet testing, including NOCSAE and NFL testing. Additionally, peak kinematics occur prior to any appreciable neck flexion or hyperextension. The headform and neck were secured to a 16 kilogram (kg) sliding mass and adjustable table, which mimics a 50th percentile male's effective torso mass during a head impact. The pendulum arm was composed of 10.16×5.8 cm rectangular aluminum tubing, was 190.5 cm long, and had a moment of inertia of 72 kg m². The arm had a total mass of 36.3 kg, including the 16.3 kg impacting mass. The pendulum arm was raised and released by a winch system and electromagnet.

The pendulum impact testing apparatus 400 was used to impact three locations in one example: the front, side, and back (e.g., see FIGS. 5A-5C and Table 2). The three locations were tested at two impact speeds, 4.0 m/s and 6.3 m/s, for a total of six impact conditions. The 4.0 m/s and 6.3 m/s impact speeds were chosen to represent the range of fall heights present in equestrian sports. For each helmet model, the six impact conditions were tested twice and averaged. The 45 equestrian helmet models tested in these six impact configurations resulted in a total of 540 impact tests. Four helmets of each model were tested, for a total of 180 helmets, to ensure that each impact location was only impacted once per helmet. Each of the four test helmets were impacted 3 times, each impact in a different location to prevent any deformation from influencing subsequent impact tests.

Table 2 includes data regarding example NOCSAE headform translations and rotations on a linear slide table using the SAE J211 coordinate system for each pendulum impact location. The zero position was defined as 0° rotation about the Y and Z axes, with the intersection of the headform's midsagittal and transverse planes aligned to the center of the impactor.

TABLE 2
Example NOCSAE headform translations and rotations

| Location | Y (cm) | Z (cm) | Ry (deg) | Rz (deg) |
|---|---|---|---|---|
| Front | 0 | +0.8 | −30° | 0° |
| Side | −1 | +4.8 | −10° | −100° |
| Back | 0 | +6.3 | 0° | 180° |

At box 1009, the method 1000 includes generating acceleration data for the oblique and pendulum impact tests completed at boxes 1003 and 1006, respectively. To measure impact response kinematics during either or both of such oblique and pendulum impact tests, a NOCSAE headform such as the headform 100 wearing the helmet 503 was instrumented with a six-degree-of-freedom sensor package in one example. For instance, the helmeted headform 880 was instrumented with a six-degree-of-freedom sensor package such as three linear accelerometers and a tri-axis angular rate sensor at the headform's center of gravity. Data was sampled at 20 kilohertz (kHz) and filtered using a 4-pole Butterworth low pass filter in this example. Linear acceleration data were filtered with a cutoff frequency of 1650 hertz (Hz) (CFC 1000) according to SAE J211, and angular rate data were filtered with a cutoff frequency of 300 Hz (CFC 180) in this example. Rotational acceleration data were calculated through five-point stencil differentiation of the angular rate data in this example.

To compare the oblique impact testing apparatus 800 and pendulum impact testing apparatus 400 resultant linear and rotational head accelerations, the Pearson's product-moment correlation coefficients between the peak accelerations within each system and across the two systems were calculated in one example. For each of the helmet models, the peak linear and rotational accelerations across impact conditions (e.g., location and speed) were first averaged within each system in this example. By averaging across impact conditions, the relationship between the peak accelerations generated on each test system by helmet model was examined in this case. Computation of the correlation between peak linear and rotational accelerations within the oblique impact testing apparatus 800, peak linear and rotational accelerations within the pendulum impact testing apparatus 400, peak linear accelerations across the two systems, and peak rotational accelerations across the two systems was then completed in this example.

At box 1012, the method 1000 includes determining injury risk values for the oblique and pendulum impact tests completed at boxes 1003 and 1006 based at least in part on the acceleration data generated at box 1009. In many examples, the injury risk values for the oblique and pendulum impact tests can be determined at box 1012 by implementing the updated Equestrian STAR helmet rating system described below. For instance, the injury risk values for the oblique and pendulum impact tests can be determined in many cases using Equation 4 of the updated Equestrian STAR system and methodology described below.

The results from the above-described statistical analysis suggested that unique information on equestrian helmet performance is provided through oblique testing. To leverage such unique information, the method 1000 and other embodiments of the present disclosure incorporate oblique tests into the previous Equestrian STAR helmet rating system as described further herein.

The updated Equestrian STAR score was calculated in one example using the resultant linear and rotational head accelerations from pendulum and oblique impact testing and Equation 4 (Eq. 4) defined below. The updated Equestrian STAR system and methodology includes and uses Equation 4 to summarize data from 8 impact conditions into one overall score: 6 impact conditions on the pendulum impactor (e.g., the front, side, and back at 6.3 m/s and 4.0 m/s) and 2 impact conditions on the oblique drop tower (e.g., the front boss and rear boss at 6.56 m/s). Equation 4 of the updated Equestrian STAR system and methodology is broken into two equations, the previously defined Equation 2 (Eq. 2) and Equation 3 (Eq. 3) defined below. The updated Equestrian STAR system and method embodiments include and use Equations 2 and 3 in connection with pendulum impactor testing (e.g., via pendulum impact testing apparatus 400) and oblique drop tower testing (e.g., via the oblique impact testing apparatus 800), respectively. By calculating the STAR scores for pendulum and oblique impacts separately and then combining them, the performance quantified by the impacts in both systems are weighted equally. In both equations, E represents exposure, which is a function of location (L) and impact velocity (V). R represents concussion risk, which is a function of peak linear acceleration (a) and peak rotational acceleration (∝).

$$Equestrian STAR = Equestrian {STAR}_{pendulum} + Equestrian {STAR}_{oblique} \qquad ( Eq . 4 )$$

$$Equestrian {STAR}_{pendulum} = {\sum }_{L = 1}^{3} {\sum }_{V = 1}^{2} E ( L , V ) * R ( a , ∝ ) \qquad ( Eq . 2 )$$

$$Equestrian {STAR}_{oblique} = {\sum }_{L = 1}^{2} {\sum }_{V = 1}^{1} E ( L , V ) * R ( a , ∝ ) \qquad ( Eq . 3 )$$

At box 1015, the method 1000 includes determining exposure values for each impact condition in the oblique and pendulum impact tests completed at boxes 1003 and 1006. In one example, exposure values for each impact condition were assigned based on equestrian fall data. In a previous analysis of equestrian fall videos, it was determined that the front, side, and back of the head are all commonly impacted. This is supported by other published studies, which also found that locations across equestrian helmets are impacted in similar frequencies during equestrian falls. Given that each head location is commonly impacted in equestrian environments, each impact location was treated as having a similar exposure (Table 3).

It was determined through video analysis in various examples that most equestrian falls occur from lower, reduced fall heights, which are approximately 3 times as frequent as falls from the full height of the horse. Similar to the results from video analysis, another study also found that most equestrian falls occur at lower impact speeds, between 3.5 m/s and 4.0 m/s. Based on data from video analysis and previous studies, the low-energy tests were assigned a higher weighting than the high-energy tests, given that riders experience the low-energy impacts more often. The low-speed impacts at 4.0 m/s were assigned an exposure value of 3 in one example, and the high-speed impacts were assigned a value of 1 in this example.

TABLE 3
Example exposure values for each head
impact condition (n/a = not applicable)

| | Pendulum | | Oblique |
|---|---|---|---|
| Impact Location | 4.0 m/s | 6.3 m/s | 6.56 m/s |
| Front | 3 | 1 | n/a |
| Side | 3 | 1 | n/a |
| Back | 3 | 1 | n/a |
| Front Boss | n/a | n/a | 1 |
| Rear Boss | n/a | n/a | 1 |

The bivariate injury risk function, defined as R(a, ∝) in the equations above, calculates the probability of a concussion resulting from an impact for a given peak linear and rotational head acceleration. This risk function was developed using head acceleration data collected from high school and college football players. Using a multivariate logistic regression analysis, concussion risk was modeled as a function of both linear and rotational head acceleration. The ability of the risk function to accurately predict concussion risk was assessed through NFL head impact reconstructions along with the original impact data used to create the risk function.

At box 1018, the method 1000 includes determining an injury risk metric for one or more helmets such as one or more of the helmet 503. For each of the above described eight impact conditions, the calculated risk was multiplied by the exposure for the tested impact location and speed to compute a weighted risk of concussion in one example. These eight weighted risks were then summed into an overall STAR score (e.g., the overall injury risk metric 678 plus the overall oblique injury risk metric 978), which was then used to determine a helmet model's star rating (e.g., for consumer interpretation) in another example. Star ratings range from 0 to 5 stars, with 5-star ratings given to helmets that greatly reduce concussion risk. Because lower STAR scores indicate a lower risk of concussion, helmets with a low STAR score will have ratings with more stars.

The star rating thresholds were set after calculating the STAR scores for 45 selected equestrian helmets in one example. Each threshold was set relative to the mean STAR score, for instance, the 5-star threshold represented a 50% reduction in STAR score compared to the mean, and each subsequent threshold was established by incrementally increasing the required STAR score by 50% of the 5-star threshold.

The flowchart in each of FIGS. 7 and 10 shows an exemplary implementation of the methods described herein, as applied to testing for concussion mitigation performance of helmets. Although the flowchart in each of FIGS. 7 and 10 shows a specific order of execution, it is understood that the order of execution may differ from that which is depicted. For example, the order of execution of two or more blocks may be scrambled relative to the order shown. Also, two or more blocks shown in succession in each of FIGS. 7 and 10 may be executed concurrently or with partial concurrence. Further, in some embodiments, one or more of the blocks shown in each of FIGS. 7 and 10 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. As referenced herein in the context of quantity, the terms “a” or “an” are intended to mean “at least one” and are not intended to imply “one and only one.”

As referred to herein, the terms “include,” “includes,” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling, etcetera (etc.)), mechanical coupling, operative coupling, optical coupling, and/or physical coupling.

Approximating language, as used herein throughout the specification, the appended claims, and/or the accompanying drawings are applied to modify any quantitative representation that could permissibly vary without resulting in a change in the basic function to which it is related. Accordingly, a value modified by a term or terms, such as “about,” “approximately,” and/or “substantially,” are not to be limited to the precise value specified. In some embodiments, the approximating language can correspond to the precision of an instrument for measuring the value. For example, the approximating language can refer to being within a 10 percent (%) margin. For instance, as used herein, the term or terms “about,” “approximately,” and/or “substantially” in conjunction with a numerical value can refer to within 10% of the indicated numerical value.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method of evaluating a helmet, comprising:
applying a pendulum impact test to one or more helmets;
applying an oblique impact test to the one or more helmets;
obtaining a plurality of linear and angular acceleration values associated with each of the pendulum impact test and the oblique impact test;
determining a plurality of injury risk values associated with each of the pendulum impact test and the oblique impact test based at least in part on the plurality of linear and angular acceleration values associated with each of the pendulum impact test and the oblique impact test; and
determining an overall injury risk metric for the one or more helmets based at least in part on the plurality of injury risk values and a plurality of exposure values associated with each of the pendulum impact test and the oblique impact test.

2. The method of claim 1, wherein applying the oblique impact test comprises:
applying a first oblique impact test configuration to the one or more helmets, the first oblique impact test configuration comprising a first pair of single oblique impacts to a front boss of individual ones of the one or more helmets at a defined velocity; and
applying a second oblique impact test configuration to the one or more helmets, the second oblique impact test configuration comprising a second pair of single oblique impacts to a rear boss of the individual ones of the one or more helmets at the defined velocity.

3. The method of claim 2, wherein:
the first pair of single oblique impacts comprises a single oblique impact applied separately to each of a left front boss and a right front boss of the individual ones of the one or more helmets at the defined velocity; and
the second pair of single oblique impacts comprises a single oblique impact applied separately to each of a left rear boss and a right rear boss of the individual ones of the one or more helmets at the defined velocity.

4. The method of claim 2, wherein each of the first oblique impact test configuration and the second oblique impact test configuration is applied using an oblique drop tower apparatus having an anvil with an angled and at least partly abrasive surface.

5. The method of claim 4, wherein the angled and at least partly abrasive surface is angled at an angle of approximately 45 degrees.

6. The method of claim 4, wherein applying the first oblique impact test configuration and the second oblique impact test configuration further comprises positioning the one or more helmets on a dummy headform and securing the dummy headform with the one or more helmets to a support ring and adjustable rods, the support ring and adjustable rods being components of the oblique drop tower apparatus.

7. The method of claim 2, wherein the defined velocity is approximately 6.56 meters per second (m/s).

8. The method of claim 1, wherein:
the one or more helmets comprise a first helmet, a second helmet, a third helmet, a fourth helmet, and a fifth helmet; and
the second helmet, the third helmet, the fourth helmet, and the fifth helmet are each a same model as the first helmet.

9. The method of claim 8, wherein:
applying the pendulum impact test to the one or more helmets comprises applying the pendulum impact test to the first helmet, the second helmet, the third helmet, and the fourth helmet; and
applying the oblique impact test to the one or more helmets comprises applying the pendulum impact test to the fifth helmet.

10. The method of claim 1, wherein applying the pendulum impact test comprises:
applying a first impact configuration to a first helmet and a second helmet of the one or more helmets, the first impact configuration comprising a first pair of single pendulum impacts applied separately to a front of each of the first helmet and the second helmet at a first velocity, a second pair of single pendulum impacts applied separately to a side of each of the first helmet and the second helmet at a second velocity, and a third pair of single pendulum impacts applied separately to a rear of each of the first helmet and the second helmet at the first velocity; and
applying a second impact configuration to a third helmet and a fourth helmet of the one or more helmets, the second impact configuration comprising a fourth pair of single pendulum impacts applied separately to a front of each of the third helmet and the fourth helmet at the second velocity, a fifth pair of single pendulum impacts applied separately to a side of each of the third helmet and the fourth helmet at the first velocity, and a sixth pair of single pendulum impacts applied separately to a rear of each of the third helmet and the fourth helmet at the second velocity.

11. The method of claim 10, wherein the first velocity is approximately 5.0 meters per second (m/s) and the second velocity is approximately 6.3 m/s.

12. The method of claim 1, further comprising:
determining the plurality of exposure values associated with each of the pendulum impact test and the oblique impact test, the plurality of exposure values comprising an exposure value for each of a front, a front boss, a side, a rear, and a rear boss of the one or more helmets, wherein each of the plurality of exposure values comprises a whole number denoting a relative frequency of impact that could occur at the front, the front boss, the side, the rear, and the rear boss of the helmet, respectively.

13. The method of claim 1, wherein determining the plurality of injury risk values further comprises performing logistic regression analyses as functions of the plurality of linear and angular acceleration values associated with each of the pendulum impact test and the oblique impact test.

14. The method of claim 1, wherein each of the one or more helmets is an equestrian helmet.

15. A method of evaluating a helmet, comprising:
applying a first impact configuration to the helmet and a second helmet that is a same model as the helmet, the first impact configuration comprising a first pair of single impacts applied separately to a front of each of the helmet and the second helmet at a first velocity, a second pair of single impacts applied separately to a side of each of the helmet and the second helmet at a second velocity, and a third pair of single impacts applied separately to a rear of each of the helmet and the second helmet at the first velocity;
applying a second impact configuration to a third helmet and a fourth helmet that are each the same model as the helmet, the second impact configuration comprising a fourth pair of single impacts applied separately to a front of each of the third helmet and the fourth helmet at the second velocity, a fifth pair of single impacts applied separately to a side of each of the third helmet and the fourth helmet at the first velocity, and a sixth pair of single impacts applied separately to a rear of each of the third helmet and the fourth helmet at the second velocity;
applying a third impact configuration to a fifth helmet that is the same model as the helmet, the third impact configuration comprising at least a single impact applied to a front boss of the fifth helmet at a third velocity and at least a single impact applied to a rear boss of the fifth helmet at the third velocity;
obtaining a plurality of linear and angular acceleration values associated with the first impact configuration, the second impact configuration, and the third impact configuration;
determining a plurality of injury risk values associated with the first impact configuration, the second impact configuration, and the third impact configuration; and
determining an overall injury risk metric for the helmet based on the plurality of injury risk values and a plurality of exposure values associated with the first impact configuration, the second impact configuration, and the third impact configuration.

16. The method of claim 15, wherein:
for the third impact configuration to the fifth helmet, the single impact to the front boss of the fifth helmet is a single impact to a left front boss of the fifth helmet, and the single impact to the rear boss of the fifth helmet is a single impact to a left rear boss of the fifth helmet; and
the third impact configuration further comprises a single impact applied to a right front boss of the fifth helmet at the third velocity and a single impact applied to a right rear boss of the fifth helmet at the third velocity.

17. The method of claim 15, wherein the overall injury risk metric is further determined by summating each individual overall injury risk metric of the first impact configuration, the second impact configuration, and the third impact configuration.

18. The method of claim 15, wherein:
the first impact configuration and the second impact configuration are applied using a pendulum impactor; and
the third impact configuration is applied using an oblique drop tower apparatus.

19. The method of claim 18, wherein:
the oblique drop tower apparatus comprises an anvil with an angled and at least partly abrasive surface; and
the fifth helmet is dropped onto the angled and at least partly abrasive surface for the third impact configuration.

20. The method of claim 15, wherein the first velocity, the second velocity, and the third velocity are all different from each other.
